(19) United States
(12) Patent Application Publication
(10) Pub. No.: US 2024/0200741 A1
(43) Pub. Date: Jun. 20, 2024

(54) APPARATUS AND METHOD FOR DRIVING LAMP

(71) Applicants: HYUNDAI MOTOR COMPANY, Seoul (KR); KIA CORPORATION, Seoul (KR)

(72) Inventor: Moon Soo Park, Gwangmyeong-si (KR)

(21) Appl. No.: 18/219,380

(22) Filed: Jul. 7, 2023

(30) Foreign Application Priority Data
Dec. 14, 2022 (KR) 10-2022-0175182

(51) Int. Cl. F21S 41/153; H05B 45/305

(52) U.S. Cl. CPC F21S 41/153; H05B 45/305

(57) ABSTRACT

An apparatus for driving a lamp includes an LED array module having a light emitting pattern adjusted in a function or mode, a body domain controller that detects a user input or a preset event and generates a control signal including control information for controlling the LED array module corresponding to the user input or the event, and an LED driver module that receives the control signal from the body domain controller through a wire and operates the LED array module in a preset function or mode corresponding to the control information of the control signal.

### CROSS REFERENCE TO RELATED APPLICATIONS

This application claims the benefit of priority to Korean Patent Application No. 10-2022-0175182, filed in the Korean Intellectual Property Office on Dec. 14, 2022, the entire contents of which are incorporated herein by reference.

### TECHNICAL FIELD

The present disclosure relates to an apparatus and method for driving a lamp, and more particularly, to a technology for driving a headlamp and a rear combination lamp of a vehicle.

### BACKGROUND

Recently, a technology for individually controlling the LEDs by implementing a headlamp and a rear combination lamp of a vehicle with a plurality of light emitting diodes (LEDs) has been applied.

A LED lamp implementing various types of light emission patterns may improve users' visual satisfaction and provide various convenience functions. A technology for implementing various functions using LED lamps has been researched, and there is a high possibility that new functions are added accordingly.

The process of implementing a light emitting pattern of an LED lamp in a new manner is based on controller area network (CAN) communication. In recent years, as a configuration for controlling a LED lamp has been integrated into a body domain controller (BDC) for a vehicle, a CAN receiver is required when adding a new function to a vehicle.

Therefore, when there is no CAN receiver in a lamp of a vehicle using an integrated controller, it is impossible to apply a new function.

In addition, when the integrated controller is not used, hardware for controlling a lamp must be added in order to add a new function of a LED lamp.

### SUMMARY

The present disclosure has been made to solve the above-mentioned problems occurring in the prior art while advantages achieved by the prior art are maintained intact.

An aspect of the present disclosure provides an apparatus and method for driving a lamp capable of applying a new function to an LED lamp to which a CAN receiver is not applied.

In addition, another aspect of the present disclosure provides an apparatus and method for driving a lamp capable of driving an LED lamp in various forms without adding hardware.

In addition, still another aspect of the present disclosure provides an apparatus and method for driving a lamp capable of implementing various lamp driving patterns through software updates.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for driving a lamp includes an LED array module having a light emitting pattern adjusted in a function or mode, a body domain controller that detects a user input or a preset event and generates a control signal including control information for controlling the led array module corresponding to the user input or the event, and an LED driver module that receives the control signal from the body domain controller through a wire and operates the LED array module in a preset function or mode corresponding to the control information of the control signal.

According to an embodiment, the body domain controller may differently set a duty of the control signal according to the user input or the event.

According to an embodiment, the LED driver module may determine the duty of the control signal during a first period, and drive the LED array module according to the duty during a second period.

According to an embodiment, the LED driver module may stop driving of the LED array module when a period for which the control signal is applied as a low level voltage is equal to or longer than a period of a low level voltage of a minimum duty.

According to an embodiment, the body domain controller may generate a first control signal having a duty that determines a function of the led array module according to the user input or the event, and generate a second control signal having a duty that determines an operation mode of the function according to the user input or the event.

According to an embodiment, the body domain controller may transmit the first control signal to the LED driver module through a first wire, and transmit the second control signal to the LED driver module through a second wire.

According to an embodiment, the body domain controller may transmit the first control signal for determining the function of the lamp according to the user input or the event during a function information transmission period, and transmit the second control signal for determining the operation mode of the function according to the user input or the event during a mode information transmission period.

According to an embodiment, the body domain controller may differently set a frequency of the control signal according to the user input or the event.

According to an embodiment, the body domain controller may differently set a voltage level of the control signal according to the user input or the event.

According to an embodiment, the LED driver module may operate the LED array module in one of a lighting show function, a welcome light function, an escort light function, or a road projection function.

According to an embodiment, the LED driver module may differently set a lighting pattern of the LED array module according to the mode.

According to an aspect of the present disclosure, a method of driving a lamp includes detecting, by a body domain controller, a user input or a preset event and generating a control signal including control information for controlling an LED array module corresponding to the user input or the event, transmitting, by the body domain controller, the control signal to an LED driver module through a wire, and operating, by the LED driver module, the LED array module in a preset function or mode corresponding to the control information of the control signal.

According to an embodiment, the generating of the control signal may include differently setting a duty of the control signal according to the user input or the event.

According to an embodiment, the operating of the LED array module may include determining the duty of the control signal during a first period, and driving the LED array module according to the duty during a second period.

According to an embodiment, the operating of the LED array module corresponding to the duty of the control signal may include stopping driving of the LED array module when a period for which the control signal is applied as a low level voltage is equal to or longer than a period of a low level voltage of a minimum duty.

According to an embodiment, the generating of the control signal may include generating a first control signal having a duty that determines a function of the LED array module according to the user input or the event, and generating a second control signal having a duty that determines an operation mode of the function according to the user input or the event.

According to an embodiment, the transmitting of the control signal may include transmitting the first control signal to the LED driver module through a first wire, and transmitting the second control signal to the LED driver module through a second wire.

According to an embodiment, the transmitting of the control signal may include transmitting the first control signal for determining the function of the lamp according to the user input or the event during a function information transmission period, and transmitting the second control signal for determining the operation mode of the function according to the user input or the event during a mode information transmission period.

According to an embodiment, the generating of the control signal may include differently setting a frequency of the control signal according to the user input or the event.

According to an embodiment, the generating of the control signal may include differently setting a voltage level of the control signal according to the user input or the event.

According to an embodiment, the operating of the led array module in the preset function or mode may include operating the led array module in one of a lighting show function, a welcome light function, an escort light function, or a road projection function.

According to an embodiment, the operating of the LED array module in the preset function or mode may include differently setting a lighting pattern of the LED array module according to the mode.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating the configuration of an apparatus for driving a lamp according to an embodiment of the present disclosure;

FIG. 2 is a flowchart illustrating a vehicle control method according to an embodiment of the present disclosure;

FIG. 3 is a diagram illustrating an example of classifying control information using a frequency of a control signal;

FIG. 4 is a diagram illustrating an example of classifying control information using a voltage level of a control signal;

FIG. 5 is a block diagram illustrating the configuration of an apparatus for driving a lamp according to another embodiment of the present disclosure;

FIG. 6 is a diagram illustrating examples of first and second control signals;

FIG. 7 is a flowchart illustrating the operation of an LED driver module;

FIGS. 8A, 8B, 9A, 9B, 10A, 10B, 11A, and 11B are diagrams illustrating an operating state of an LED array module;

FIG. 12A is a schematic diagram illustrating an apparatus for driving a lamp according to a comparative example;

FIG. 12B is a schematic diagram illustrating an apparatus for driving a lamp according to an embodiment of the present disclosure; and

FIG. 13 is a block diagram illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

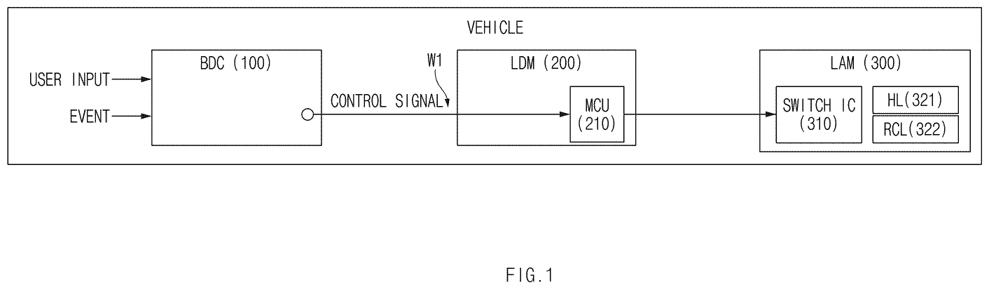

Hereinafter, with reference to FIGS. 1 to 13, embodiments of the present disclosure will be described in detail.

FIG. 1 is a block diagram illustrating the configuration of an apparatus for driving a lamp according to an embodiment of the present disclosure. An apparatus for driving a lamp shown in FIG. 1 may be a driving apparatus for a vehicle lamp.

Referring to FIG. 1, an apparatus for driving a lamp according to an embodiment of the present disclosure may include a body domain controller (BDC) 100, an LED driver module (LDM) 200, and an LED array module (LAM) 300.

The BDC 100 may detect a user input or event and may generate a control signal corresponding to the user input or event.

The user input may be detected through a user input device in a vehicle VEH, where the user input device may be a handle lever coupled to a steering wheel, and may be provided through a cluster or the like.

The event may correspond to a condition for driving the LAM 300, and may be set in advance. For example, an event may be generated when it is detected that a user has approached a vehicle within a certain distance. Alternatively, an event may be generated when a user moves out of a certain distance from the vehicle.

The control signal may include control information, and the control information may be information for determining a function of the LAM 300 or an operation mode for the function. The control information may be classified based on differently setting a duty, frequency or voltage level of the control signal.

The LDM 200 may receive a control signal from the BDC 100 through a wire W1 and drive the LAM 300 corresponding to the control information of the control signal.

For example, the LDM 200 may operate the LAM 300 in one of a lighting show function, a dynamic welcome lighting (DWL) function, a dynamic escort lighting (DEL) function, or a road projection function.

In addition, the LDM 200 may drive the LAM 300 in a selected function, but may drive the LAM 300 differently depending on a mode. The mode of the LAM 300 may be to determine light emitting patterns of LED lamps. For example, an arbitrary function of the LAM 300 may be driven in a plurality of modes, and the number of LED lamps emitting light and the light emitting order may be different even for the same function.

For example, the LDM 200 may determine the function and operation mode of the LAM 300 according to the duty of a control signal.

Alternatively, the LDM 200 may determine the function and operation mode of the LAM 300 according to the frequency of the control signal.

Alternatively, the LDM 200 may determine the function and operation mode of the LAM 300 according to the voltage level of the control signal.

To this end, the LDM 200 may receive the control signal from the BDC 100 and include a micro controller unit (MCU) 210 for transmitting a signal to a switch IC 310 of the LAM 300.

In addition, the LDM 200 may store functions and operation modes of the LAM 300 corresponding to the duty, frequency, or voltage level of the control signal in a memory (not shown) in the form of a lookup table. The memory may be configured in a combination of a hard disk drives, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous DRAM (SDRAM), a double date rate-SDRAM (DDR-SDRAM), and the like.

The LAM 300 may include a head lamp 321, and a rear combination lamp (RCL) 322. The head lamp 321 may include a plurality of light emitting diodes (hereinafter, referred to as LEDs) arranged in front of the vehicle. The rear combination lamp 322 may include a plurality of LEDs disposed at the rear of the vehicle. Some or all of the head lamp 321 and the rear combination lamp 322 may emit light under control of the switch IC 310. In addition, the head lamp 321 and the rear combination lamp 322 may have different numbers of LEDs and light emission patterns according to functions and operation modes.

The function of the LAM 300 may include a lighting show function, a dynamic welcome light (DWL) function, a dynamic escort lighting (DEL) function, or a road projection function.

The lighting show may include a function of allowing the LEDs of the LAM 300 to emit light in various patterns, and thus, the operating state of the LAM 300 or the operating state of another accessory may be displayed.

The dynamic welcome lighting may be a function of emitting light in a specific pattern to welcome the user when the user approaches the vehicle.

The dynamic escort lighting may be a function of illuminating the user's surroundings for a certain period of time when the user gets off the vehicle.

The road projection may be a function of displaying a specific image on the ground by using light emitted by LEDs by using projection mapping technology.

In addition, each function may operate in a plurality of operation modes. The operation mode of the LAM 300 may be to determine the lighting pattern of the LED lamp. For example, when the dynamic welcome lighting is a function of allowing LEDs to sequentially emitting light outwardly, the operation mode may determine the kind and number of LEDs emitting outwardly, and the timing of light emission.

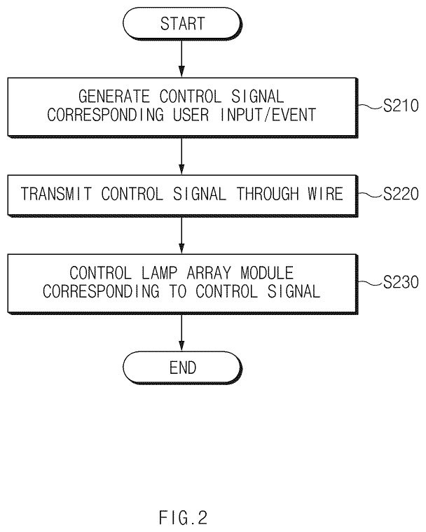

Hereinafter, a vehicle control method according to an embodiment of the present disclosure will be described in detail with reference to FIG. 2.

FIG. 2 is a flowchart illustrating a vehicle control method according to an embodiment of the present disclosure.

Referring to FIG. 2, in S210, the BDC 100 may detect a user input or event and generate a control signal corresponding to the user input or event.

The user input may be detected through a user input device in a vehicle, and may be detected through a terminal capable of remotely controlling a vehicle, such as a smart key.

The event may be a location of a user or a specific action of a user, and may be set in advance.

For example, the BDC 100 may detect a state in which the user approaches the vehicle VEH within a specified interval as a first event. Alternatively, the BDC 100 may detect a state in which the ignition of the vehicle VEH is turned off and the door is closed as a second event.

The control signal may include control information for controlling the LAM 300. The control information may be set corresponding to a user input or event.

That is, the BDC 100 may generate a control signal including control information for driving the LAM 300 in response to manipulation of the user input device.

Alternatively, the BDC 100 may generate a control signal including control information for operating the LAM 300 in a welcome function in response to the first event.

Alternatively, the BDC 100 may generate a control signal including control information for operating the LAM 300 as an escort function in response to the second event.

The control information may be classified based on the duty, frequency, or voltage level of the control signal.

For example, the BDC 100 may set the duty of the control signal in order to determine the function or operation mode of the LAM 300. A specific embodiment of a method of determining a function or operation mode using a duty will be described later.

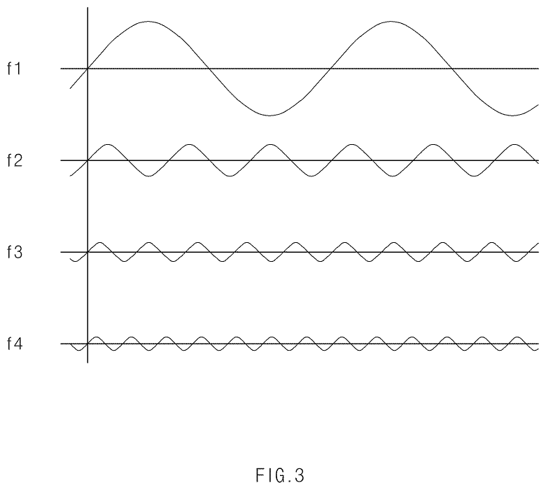

Alternatively, the BDC 100 may select a frequency of the control signal as shown in FIG. 3 in order to determine the function or operation mode of the LAM 300.

FIG. 3 is a diagram illustrating an example of classifying control information using a frequency of a control signal.

Referring to FIG. 3, the BDC 100 may generate a control signal having one of the first to fourth frequencies fl to f4. The first to fourth frequencies fl to f4 may be used to distinguish first to fourth control information from each other. For example, the BDC 100 may select the first frequency fl corresponding to first control information and may select the fourth frequency f4 corresponding to fourth control information.

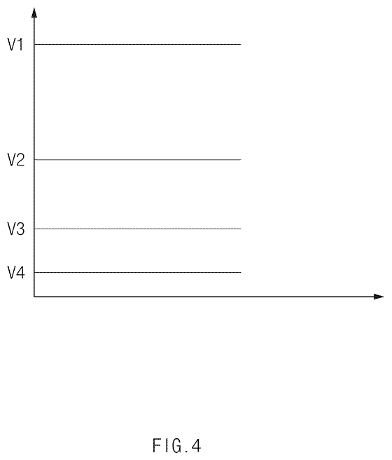

Alternatively, the BDC 100 may select the voltage level of the control signal as shown in FIG. 4 in order to determine the function or operation mode of the LAM 300.

FIG. 4 is a diagram illustrating an example of classifying control information using a voltage level of a control signal.

Referring to FIG. 4, the BDC 100 may generate a control signal having a frequency having one of first to fourth voltage levels V1 to V4. The first to fourth voltage levels V1 to V4 may be used to classify first to fourth control information. For example, the BDC 100 may select the first voltage level V1 corresponding to the first control information and may select the fourth control information V4 corresponding to the fourth control information.

The first to fourth control information may be determined according to a user input or event.

According to an embodiment, the first to fourth control information may determine the function of the LAM 300. An example of determining the function of a led array module based on control information is shown in following Table 1.

TABLE 1

| Control information | Function |
|---|---|
| First control information | First function |
| Second control information | Second function |
| Third control information | Third function |
| Fourth control information | Fourth function |

As shown in Table 1, the BDC 100 may determine different functions based on control information.

Alternatively, the first to fourth control information may determine a function of the LAM 300 and an operation mode for the function. An example of determining the function of a led array module and the operation mode for the function based on control information is shown in following Table 2.

TABLE 2

| Control information | Function/operation mode |
|---|---|
| First control information | First function and first operation mode |
| Second control information | First function and second operation mode |
| Third control information | Second function and first operation mode |
| Fourth control information | Second function and second operation mode |

As shown in Table 2, the BDC 100 may determine a function and an operation mode based on control information. For example, the first to fourth control information may determine one function and operation mode among two functions and two operation modes.

Alternatively, the BDC 100 may separately generate a control signal for determining a function and an operation mode. For example, the BDC 100 may generate a first control signal including control information for determining a function of the LAM 300 and a second control signal for determining an operation mode for the function.

The number of control information may vary depending on the function or operation mode of the led array module.

In S220, the BDC 100 may transmit a control signal to the LDM 200 through the wire W1.

Depending on the type of control information, the BDC 100 may transmit a control signal having a different duty, frequency, or voltage level through the wire W1.

When the control signal includes the first control signal and the second control signal, the BDC 100 may transmit the first control signal and the second control signal separately in time or space.

For example, the BDC 100 may transmit the first control signal during a function information transmission period and may transmit the second control signal during a mode information transmission period. The function information transmission period and the mode information transmission period may be non-overlapping periods.

Alternatively, the wire W1 may be classified into a first wire for transmitting the first control signal and a second wire for transmitting the second control signal. A specific example thereof will be described later.

In S230, the LDM 200 may drive the LAM 300 corresponding to the control information.

The LDM 200 may operate the LAM 300 in one of a lighting show function, a dynamic welcome lighting function, a dynamic escort lighting function, or a road projection function.

The LDM 200 may operate in an efficient mode or an active mode for each function. For example, the efficient mode may be an operation mode in which the operation pattern of the LAM 300 is simply driven. In addition, the active mode may be an operation mode in which the operation pattern of the LAM 300 is dynamically driven.

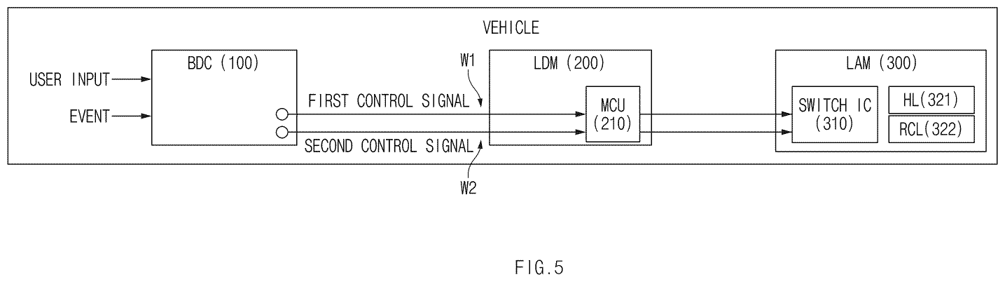

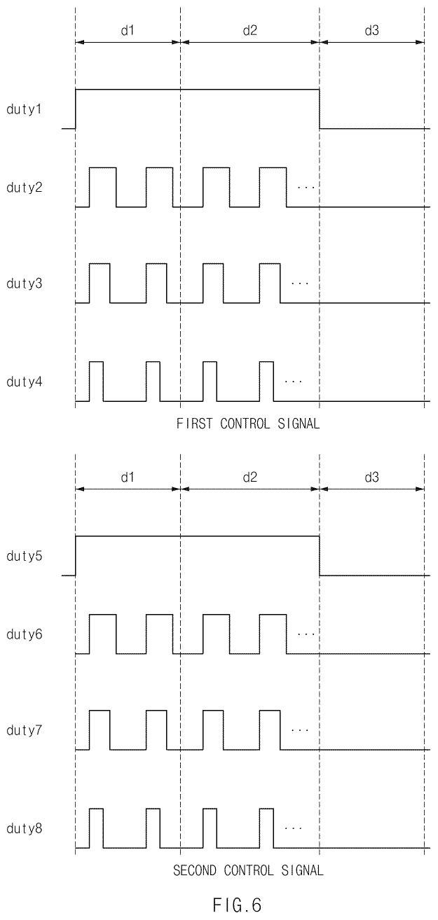

FIG. 5 is a block diagram illustrating the configuration of an apparatus for driving a lamp according to another embodiment of the present disclosure. FIG. 6 is a diagram illustrating examples of first and second control signals. In the embodiment shown in FIG. 5, detailed descriptions of components substantially the same as those of the above-described embodiment will be omitted.

Referring to FIGS. 5 and 6, an apparatus for driving a lamp according to another embodiment of the present disclosure may include the BDC 100, the LDM 200, and the LAM 300.

The BDC 100 may generate a first control signal and a second control signal. The first control signal and the second control signal may distinguish control information using the size of a duty.

The first control signal may have one of first to fourth duties duty1 to duty4.

The size of the duty may be set in consideration of a voltage error and a duty value error. For example, when the vehicle voltage is 12V, the actual measured voltage may be in the range of about 8.89 V to 15.26 V. That is, when the control signal is generated based on the vehicle voltage, the error range of the voltage level may be about 27%. In addition, the duty error may be set to 1% in consideration of an error range of a general semiconductor device. As described above, considering the voltage error and the duty value error, the sizes of a low duty and a high duty may be set such that an arbitrarily set low duty is not recognized as a high duty. That is, the sizes of the low duty and the high duty may be set to satisfy the condition of “(1+voltage error)×(low duty+duty error)<(1-voltage error)×(high duty—duty error)”. When the voltage error is 27% and the duty error is 1%, the above condition may be summarized as “high duty>1.73× low duty+2.85”.

Accordingly, when the low duty is 10%, the high duty may be set to 20.15% or more. For example, the high duty may be set to 25%.

Similarly, when a size of 25% is set as the low duty, the high duty may be set to 46.1% or more, for example, to 50%.

In such a manner, the duties may be set to a size of 10, 25, 50, or 100. That is, the first duty duty1 may be set to 100, the second duty duty2 to 50, the third duty duty3 to 25, and the fourth duty duty4 to 10.

The second control signal may have one of the fifth duty duty5 to the eighth duty duty8. The fifth duty duty5 to the eighth duty duty8 may be set to different sizes or the same size as the first duty duty1 to the fourth duty duty4. For example, the fifth duty duty5 may be set to 100, the sixth duty duty6 to 50, the seventh duty duty7 to 25, and the eighth duty duty8 to 10.

The duty of the first control signal may determine the function of the LAM 300, and the duty of the second control signal may determine the operation mode for the function of the LAM 300.

An example of a function matched to the duty of the first control signal is shown in following Table 3, and an example of an operation mode matched to the duty of the second control signal is shown in following Table 4.

TABLE 3

| Duty | Function |
|---|---|
| Duty1 (100%) | Lighting show |
| Duty2 (50%) | Dynamic welcome lighting |
| Duty3 (25%) | Dynamic escort lighting |
| Duty4 (10%) | Road projection |

Referring to Table 3, the first control signal may be a signal having one among the first to fourth duties duty1 to duty4. The first to fourth duties duty1 to duty4 may correspond to control information for determining a function.

The BDC 100 may generate the first control signal having the first duty duty1 corresponding to a user input or event of requesting the lighting show function.

The BDC 100 may generate the first control signal having the second duty duty2 corresponding to an event of indicating the dynamic welcome lighting function.

The BDC 100 may generate the first control signal having the third duty duty3 corresponding to an event of indicating the dynamic escort lighting function.

The BDC 100 may generate the first control signal having the fourth duty duty4 corresponding to a user input or an event of requesting the road projection function.

TABLE 4

| Duty | Operation mode |
|---|---|
| Duty5 (100%) | Mode 1 |
| Duty6 (50%) | Mode 2 |
| Duty7 (25%) | Mode 3 |
| Duty8 (10%) | Mode 4 |

Referring to Table 4, the second control signal may be a signal having one of the fifth to eighth duties duty5 to duty8. The fifth to eighth duties duty5 to duty8 may be set to the same size as the first to fourth duties duty1 to duty4. The fifth to eighth duties duty5 to duty8 may correspond to control information for determining an operation mode.

The BDC 100 may generate the second control signal having the fifth duty duty5 corresponding to a user input or an event of requesting the first mode. Similarly, the BDC 100 may determine one of the sixth to eighth duties duty6 to duty8 corresponding to a user input or event. Alternatively, the operation mode may be in a preset state.

The BDC 100 may transmit the first control signal to the LDM 200 through the first wire W1 and transmit the second control signal to the LDM 200 through a second wire W2.

The LDM 200 may drive the LAM 300 based on the first control signal and the second control signal. A procedure of controlling the LAM 300 by the LDM 200 will be described below.

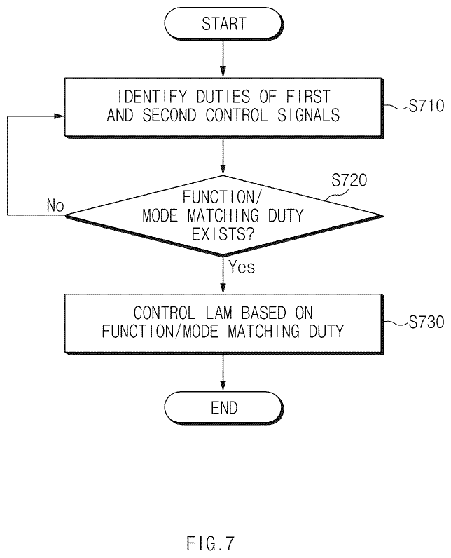

FIG. 7 is a flowchart illustrating the operation of a led driver module (LDM). The operation of the LDM will be described with reference to FIGS. 5 to 7.

In S710, the LDM 200 may identify the duty of the first control signal and the duty of the second control signal.

The LDM 200 may identify the duty of the first control signal during a first time period d1. In addition, the LDM 200 may identify the duty of the second control signal during the first time period d1.

When the function and the operation mode are the same as the embodiments defined in Table 3 and Table 4, the combination of the function and the operation mode may be one of 16 cases as shown in following Table 5.

TABLE 5

| Function | Mode1 | Mode2 | Mode3 | Mode4 |
|---|---|---|---|---|
| Lighting show | Case1 | Case2 | Case3 | Case4 |
| Dynamic welcome lighting | Case5 | Case6 | Case7 | Case8 |
| Dynamic escort lighting | Case9 | Case10 | Case11 | Case12 |
| Road projection | Case13 | Case14 | Case15 | Case16 |

In S720, the LDM 200 may determine whether the function and mode determined according to the duty exist.

According to an embodiment, all 16 cases shown in Table 5 may be defined, or specific functions and operation modes may not be defined.

For example, it may be assumed that Case 3, Case 4, Case 15, and Case 16 are not defined. In this case, when the first and second control signals received by the LDM 200 indicate Case 3 corresponding to the combination of the lighting show and the third mode, the LDM 200 may perform a procedure of identifying the duties of the first and second control signals again.

In S730, the LDM 200 may control the LAM 300 based on a function and a mode indicated by the first and second control signals.

The LDM 200 may drive the LAM 300 during the second time period d2 based on the determination result in the first time period d1.

For example, when the first and second control signals received during the first time period d1 indicate Case 6, the LDM 200 may drive the LAM 300 during the second time period d2 in the dynamic welcome light function of the second operation mode.

In addition, the LDM 200 may stop driving the LAM 300 when the voltage level of the control signal continues to be at a low level voltage. For example, the LDM 200 may stop driving the LAM 300 when the voltage level of at least one of the first control signal or the second control signal continues beyond a low level voltage time period of the minimum duty.

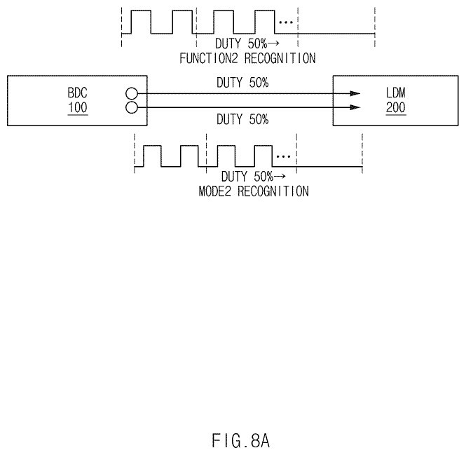

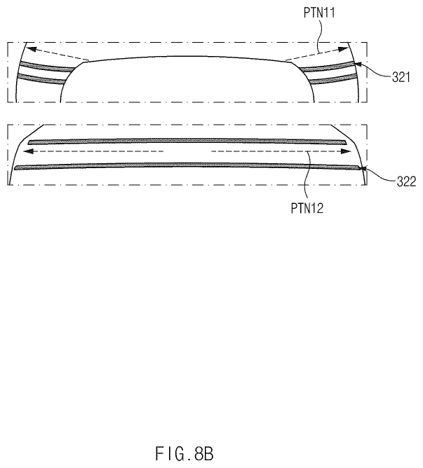

With reference to FIGS. 8 to 11, detailed examples will be described below. FIGS. 8 to 11 are diagrams illustrating an operating state of an LED array module (LAM) according to an embodiment. FIGS. 8 to 11 will be described focusing on embodiments of control signals defined as shown in Table 3 and Table 4. In addition, with reference to FIGS. 8 to 11, an embodiment in which the second operation mode is an efficient mode and the third operation mode is an active mode will be described.

FIG. 8A is a diagram illustrating the duty of a control signal according to an embodiment. FIG. 8B is a diagram illustrating an example of an operation pattern of an LED array module (LAM).

Referring to FIG. 8, the BDC 100 may transmit the first control signal of the second duty duty2 to the LDM 200 through the first wire W1, and transmit the second control signal of the sixth duty duty6 to the LDM 200 through the second wire W2.

The LDM 200 may determine a dynamic welcome lighting function corresponding to the second function based on the first control signal, and may determine an efficient mode corresponding to the second operation mode based on the second control signal.

In order to operate the dynamic welcome lighting function in the efficient mode, the LDM 200 may drive the head lamp 321 in the pattern of PTN11 and drive the rear combination lamp 322 in the pattern of PTN12. The efficient mode may be an operation mode in which LEDs arranged in a straight line are sequentially driven. For example, the LDM 200 may allow LEDs located on a straight line in the head lamp 321 to sequentially emit light in an outward direction. Similarly, the LDM 200 may allow LEDs located on a straight line in the rear combination lamp 322 to sequentially emit light in an outward direction.

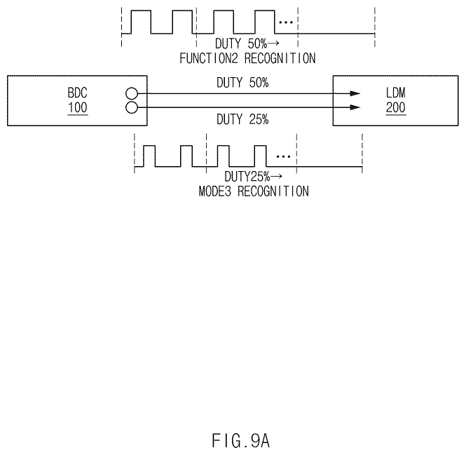

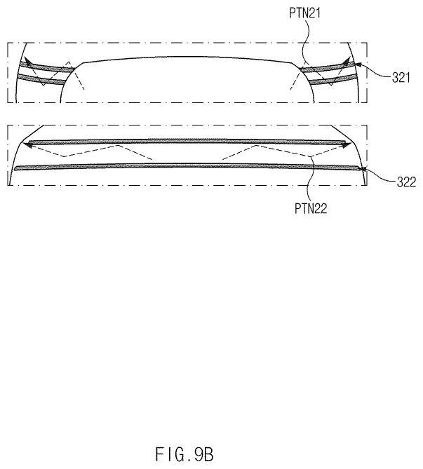

FIG. 9A is a diagram illustrating the duty of a control signal according to another embodiment. FIG. 9B is a diagram illustrating another example of an operation pattern of an LED array module (LAM).

Referring to FIG. 9, the BDC 100 may transmit the first control signal of the second duty duty2 to the LDM 200 through the first wire W1, and transmit the second control signal of the seventh duty duty7 to the LDM 200 through the second wire W2.

The LDM 200 may determine the dynamic welcome lighting function corresponding to the second function based on the first control signal, and may determine an active mode corresponding to the third operation mode based on the second control signal.

In order to operate the dynamic welcome lighting function in the active mode, the LDM 200 may drive the head lamp 321 in the pattern of PTN21 and drive the rear combination lamp 322 in the pattern of PTN22. The active mode may be an operation mode in which LEDs emit light in a sawtooth pattern. For example, the LDM 200 may allow the LEDs to emit light from the inside to the outside such that the light emitting pattern of the head lamp 321 has a sawtooth shape. Similarly, the LDM 200 may allow the LEDs to emit light from the inside to the outside such that the light emitting pattern of the rear combination lamp 322 has a sawtooth shape.

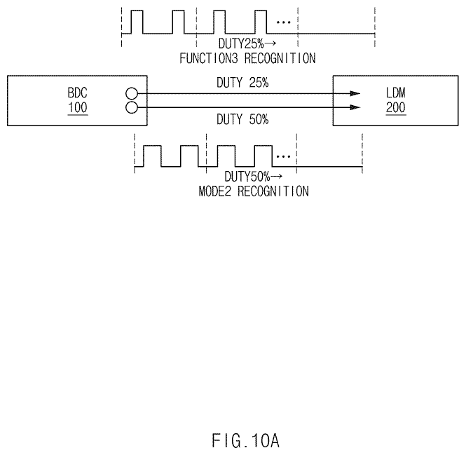

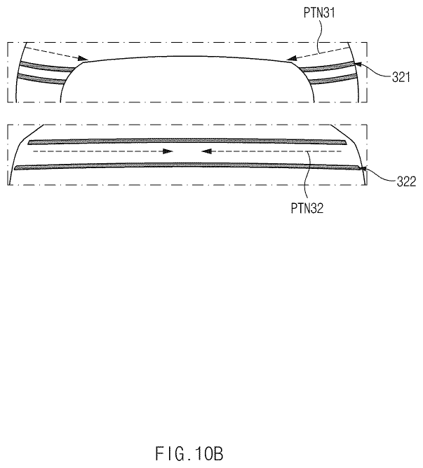

FIG. 10A is a diagram illustrating the duty of a control signal according to an embodiment. FIG. 10B is a diagram illustrating an example of an operation pattern of an LED array module.

Referring to FIG. 10, the BDC 100 may transmit the first control signal of the third duty duty3 to the LDM 200 through the first wire W1, and transmit the second control signal of the sixth duty duty6 to the LDM 200 through the second wire W2.

The LDM 200 may determine the dynamic escort lighting function corresponding to the third function based on the first control signal, and may determine the efficient mode corresponding to the second operation mode based on the second control signal.

In order to operate the dynamic escort lighting function in the efficient mode, the LDM 200 may drive the head lamp 321 in the pattern of PTN31 and drive the rear combination lamp 322 in the pattern of PTN32. The efficient mode may be an operation mode in which LEDs arranged in a straight line are sequentially driven. For example, the LDM 200 may allow LEDs located on a straight line in the head lamp 321 to sequentially emit light in an inward direction. Similarly, the LDM 200 may allow LEDs located on a straight line in the rear combination lamp 322 to sequentially emit light in an inward direction.

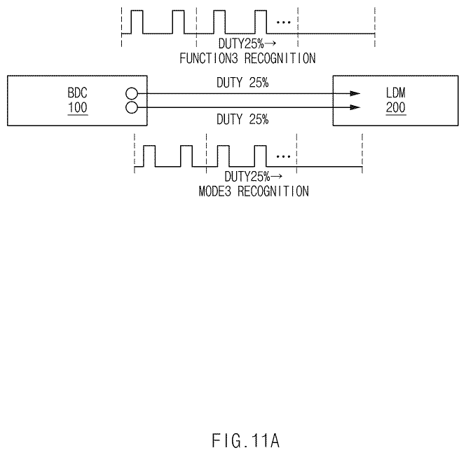

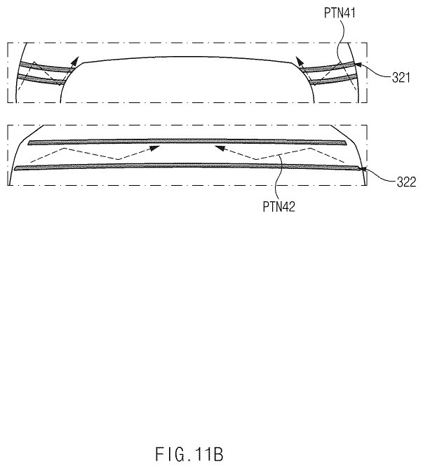

FIG. 11A is a diagram illustrating the duty of a control signal according to an embodiment. FIG. 11B is a diagram illustrating an example of an operation pattern of an LED array module.

Referring to FIG. 11, the BDC 100 may transmit the first control signal of the third duty duty3 to the LDM 200 through the first wire W1, and transmit the second control signal of the seventh duty duty7 to the LDM 200 through the second wire W2.

The LDM 200 may determine the dynamic escort lighting function corresponding to the third function based on the first control signal, and may determine an active mode corresponding to the third operation mode based on the second control signal.

In order to operate the dynamic escort lighting function in the active mode, the LDM 200 may drive the head lamp 321 in the pattern of PTN41 and drive the rear combination lamp 322 in the pattern of PTN42. The active mode may be an operation mode in which LEDs emit light in a sawtooth pattern. For example, the LDM 200 may allow the LEDs to emit light from the outside to the inside such that the light emitting pattern of the head lamp 321 has a sawtooth shape. Similarly, the LDM 200 may allow the LEDs to emit light from the outside to the inside such that the light emitting pattern of the rear combination lamp 322 has a sawtooth shape.

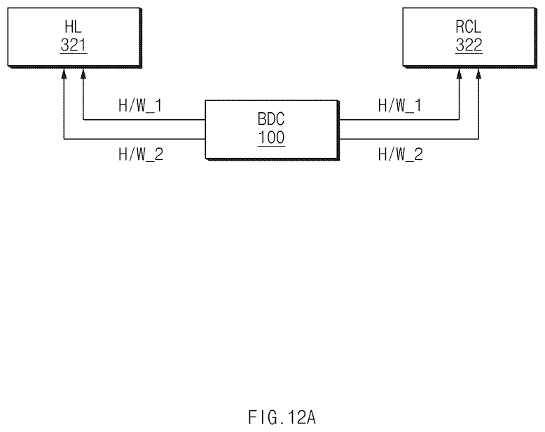

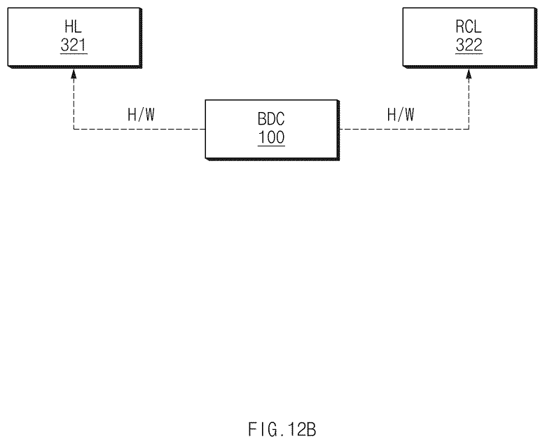

FIG. 12 is a schematic diagram illustrating an apparatus for driving a lamp according to a comparative example and an apparatus for driving a lamp according to an embodiment of the present disclosure. FIG. 12A is a schematic diagram illustrating a hardware structure of an apparatus for driving a lamp according to a comparative example. FIG. 12B is a schematic diagram illustrating a hardware structure of an apparatus for driving a lamp according to an embodiment of the present disclosure. Specifically, FIG. 12A illustrates the configuration of an apparatus for driving a lamp prior to standardization of a vehicle controller.

Referring to FIG. 12A, when an apparatus for driving a lamp according to a comparative example does not have a CAN receiver, different hardware H/W_1 and H/W_2 may be required to operate the two functions. Therefore, whenever the function of the head lamp 321 or the rear combination lamp 322 is added, hardware must be increased.

In addition, as the vehicle controller tends to be configured in a platform based on CAN communication, it is impossible to additionally apply a new function to a vehicle having no CAN communicators.

However, according to an embodiment of the present disclosure, the BDC 100 corresponding to the vehicle controller may control the function and operation mode of the head lamp 321 and the rear combination lamp 322 without being based on CAN communication. Therefore, according to an embodiment of the present disclosure, a new function of the LAM 300 may be applied even to a vehicle to which CAN communication is not applied. In addition, according to an embodiment of the present disclosure, a new function and operation mode of the LAM 300 may be applied only by changing software.

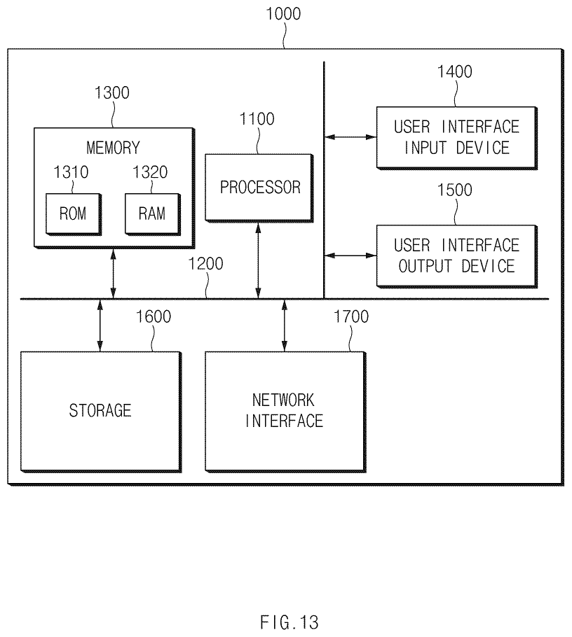

FIG. 13 is a block diagram illustrating a computing system according to an embodiment of the present disclosure.

Referring to FIG. 13, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the embodiments of the present disclosure, because the lamp module is controllable by using a control signal transmitted to the lamp driver based on wired communication, new functions may be easily applied to a LED lamp to which a CAN receiver is not applied

In addition, according to the embodiments of the present disclosure, because a new type of LED lamp driving may be implemented by varying the control information of a control signal, there is no need to add hardware for a new function.

In addition, according to the embodiments of the present disclosure, it is possible to implement various lamp driving patterns through the setting of a function and an operation mode corresponding to control information.

In addition, various effects that are directly or indirectly understood through the present disclosure may be provided.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

1. An apparatus for driving a lamp, the apparatus comprising:
a light emitting diode (LED) array module having a plurality of LEDs;
a body domain controller configured to:
detect a user input or a preset event; and
generate a control signal including control information for controlling the LED array module corresponding to the user input or the preset event; and
an LED driver module configured to:
receive the control signal from the body domain controller through a wire; and
operate the LED array module in a preset function or mode corresponding to the control information of the control signal.

2. The apparatus of claim 1, wherein the body domain controller is configured to set a duty of the control signal according to the user input or the preset event.

3. The apparatus of claim 2, wherein the LED driver module is configured to:
determine the duty of the control signal during a first period; and
drive the LED array module according to the duty during a second period.

4. The apparatus of claim 3, wherein the LED driver module is configured to:
stop driving of the LED array module when a period for which the control signal is applied as a low level voltage is equal to or longer than a period of a low level voltage of a minimum duty.

5. The apparatus of claim 2, wherein the body domain controller is configured to:
generate a first control signal having a duty that determines a function of the LED array module according to the user input or the preset event; and
generate a second control signal having a duty that determines an operation mode of the function according to the user input or the preset event.

6. The apparatus of claim 5, wherein the body domain controller is configured to:
transmit the first control signal to the LED driver module through a first wire; and
transmit the second control signal to the LED driver module through a second wire.

7. The apparatus of claim 5, wherein the body domain controller is configured to:
transmit the first control signal for determining the function of the lamp according to the user input or the preset event during a function information transmission period; and
transmit the second control signal for determining the operation mode of the function according to the user input or the preset event during a mode information transmission period.

8. The apparatus of claim 1, wherein the body domain controller is configured to set a frequency of the control signal according to the user input or the preset event.

9. The apparatus of claim 1, wherein the body domain controller is configured to set a voltage level of the control signal according to the user input or the preset event.

10. The apparatus of claim 1, wherein the LED driver module is configured to operate the LED array module in one of a lighting show function, a welcome light function, an escort light function, or a road projection function.

11. The apparatus of claim 1, wherein the LED driver module is configured to set a lighting pattern of the LED array module according to the preset function or mode.

12. A method of driving a lamp, the method comprising:
detecting, by a body domain controller, a user input or a preset event and generating a control signal including control information for controlling an LED array module corresponding to the user input or the preset event;
transmitting, by the body domain controller, the control signal to an LED driver module through a wire; and
operating, by the LED driver module, the LED array module in a preset function or mode corresponding to the control information of the control signal.

13. The method of claim 12, wherein generating the control signal includes:
setting a duty of the control signal according to the user input or the preset event.

14. The method of claim 13, wherein operating the LED array module includes:
determining the duty of the control signal during a first period; and
driving the LED array module according to the duty during a second period.

15. The method of claim 14, wherein operating the LED array module corresponding to the duty of the control signal includes:
stopping driving of the LED array module when a period for which the control signal is applied as a low level voltage is equal to or longer than a period of a low level voltage of a minimum duty.

16. The method of claim 13, wherein generating the control signal includes:
generating a first control signal having a duty that determines a function of the LED array module according to the user input or the preset event; and
generating a second control signal having a duty that determines an operation mode of the function according to the user input or the preset event.

17. The method of claim 16, wherein transmitting the control signal includes:
transmitting the first control signal to the LED driver module through a first wire; and
transmitting the second control signal to the LED driver module through a second wire.

18. The method of claim 16, wherein transmitting the control signal includes:
transmitting the first control signal for determining the function of the lamp according to the user input or the preset event during a function information transmission period; and
transmitting the second control signal for determining the operation mode of the function according to the user input or the preset event during a mode information transmission period.

19. The method of claim 12, wherein generating the control signal includes setting a frequency of the control signal according to the user input or the preset event.

20. The method of claim 12, wherein generating the control signal includes setting a voltage level of the control signal according to the user input or the preset event.
